(19) United States
(12) Patent Application Publication
(10) Pub. No.: US 2018/0058377 A1
(43) Pub. Date: Mar. 1, 2018

(54) ACTUATOR STRUCTURE AND METHOD OF IGNITION OF ELECTRICALLY OPERATED PROPELLANT

(71) Applicant: Raytheon Company, Waltham, MA (US)

(72) Inventors: James K. Villarreal, Tucson, AZ (US); Thomas W. Villarreal, Tucson, AZ (US); Frederick B. Koehler, Tucson, AZ (US); Mark T. Langhenry, Tucson, AZ (US); Matt H. Summers, Marana, AZ (US)

(21) Appl. No.: 15/247,194

(22) Filed: Aug. 25, 2016

(51) Int. Cl. F02K 9/26; F02K 9/94; F02K 9/95

(52) U.S. Cl. CPC F02K 9/26; F02K 9/95; F02K 9/94

(57) ABSTRACT

An actuator produces a displacement that maintains positive contact between an electrically operated propellant and a pair of electrodes to ignite and sustain combustion of an ignition surface. The electrodes are suitably configured such that current lines between the electrodes follow equipotential surfaces through the propellant. The displacement drives a contour of the ignition surface to substantially match an equipotential surface corresponding to a maximum and uniform current density J at a minimum gap between the electrodes to ignite and combust the entire ignition surface. The flat, angled or curved contact areas of the electrodes are suitably symmetric about a plane.

### BACKGROUND OF THE INVENTION

### Field of the Invention

This invention relates to electrically operated propellants, and more particularly to an actuator structure and method of controlled ignition of the electrically operated propellant without burn back.

### Description of the Related Art

All propellants are a combination of oxidizer, fuel, binder and additives. The oxidizer provides oxygen required to burn the fuel. The binder provides a structural material to bind the fuel and oxidizer. The binder itself is a fuel. Additional fuel may or may not be required. Additives may be used for a variety of purposes including to assist curing of the propellant, to control the burn rate, etc. Propellant may be used for gas generators, rocket motors, air bags and the like. It is desirable that substantially all of the propellant is or can be consumed.

Solid rocket motor (SRM) propellants are ignited thermally and burn vigorously to completion of the propellant. SRM propellants typically exhibit a designed burn rate and consume substantially all of the propellant. However, the burn rate cannot be independently controlled. Furthermore, once ignited, SRM propellants cannot be “turned off” except by a violent and uncontrolled depressurization. The most common oxidizer for SRM propellants is a solid ammonium perchlorate (AP). The resulting SRM propellant ignites in response to heat but is electrically inert. SRM propellants are typically initiated using a secondary pyrotechnic. This explosive is ignited via a bridgewire that heats up and transfers heat energy to the energetic material. This very sensitive energetic material then ignites the primary SRM propellant.

Electrically operated propellants are ignited by application of heat and an electric input. In a simple configuration, a voltage is applied between parallel wires embedded in the propellant. This produces ohmic heating that increases the temperature of the propellant. Application of the voltage across the propellant creates a current density (J)=current (I)/area (A) of the propellant. The current density J must exceed an ignition threshold of the propellant to ignite and burn. To support electrical operation, the oxidizer is “ionic” in the sense of providing free-flowing ions necessary for electrical control. The burn rate of the propellant may be controlled via the electric input.

Certain formulations of the propellant, and more specifically the oxidizer, allow combustion to be extinguished by interruption of the electric input as long as the chamber pressure remains less than a self-sustaining threshold pressure. The propellant may be reignited by reapplication of the electric input. Sawka's hydroxyl-ammonium nitrate (HAN) based propellant (U.S. Pat. No. 8,857,338) exhibits a threshold of about 150 psi. Villarreal's perchlorate-based propellant (U.S. Pat. No. 8,950,329) can be configured to exhibit a threshold greater than 200, 500, 1.500 and 2,000 psi. These higher threshold pressures allow for more practical applications in which the combustion may be turned on and off at elevated chamber pressures. For these reasons, electrically operated propellants are an attractive option to more mature SRM propellants.

A challenge to achieve wide spread use is to provide an electrode configuration that provides for control of the burn rate and efficient consumption of substantially all of the propellant, and one that is scalable to combust greater propellant mass to support larger gas generation systems.

As shown in FIGS. 1a-1d, a pair of parallel wire electrodes 100 and 102 are embedded in a mass of electrically operated propellant 104. A DC supply 106 applies a voltage between electrodes 100 and 102. Current flows from the positive electrode, wire 102, to the negative electrode, wire 100, along current lines 108. The spacing of current lines 108 dictates the current density J. The closer the current lines 108, the higher the current density J. In this configuration, the current density J is the highest at the negative electrode, wire 100. Testing has demonstrated that application of an electrical input to the wires creates an ignition condition in which the propellant at the surface of wire 100 is ignited and the amount of propellant that combusts is very small. The propellant burns for only a small distance away from wire 100 and extinguishes. The propellant burns down wire 100, creates an air gap and is extinguished. “Burn Back” as this is referred is an uncontrolled and inefficient process to ignite and consume propellant.

U.S. Pat. No. 8,857,338 “Electrode Ignition and Control of Electrically Ignitable Materials” also discloses an apparatus for providing electrically initiated and/or controlled combustion of electrically ignitable propellants is provided. In one example, the apparatus includes a volume of electrically ignitable propellant (solid and/or liquid), which is capable of self-sustaining combustion, and two (or more) electrodes operable to ignite the propellant. The apparatus may further include a power supply and controller in electrical communication with the electrodes for supplying a potential across the electrodes to initiate combustion of the propellant and/or control the rate of combustion of the propellant. For instance, by increasing or decreasing the power and current supplied through the propellant the rate of combustion may be varied.

Various configurations and geometries of the propellant, electrodes, and apparatus are described. In one example, the electrodes are in electrical contact with the electrically ignitable propellant and are supplied a direct current, which may cause combustion of the electrically ignitable propellant at the contact location of the positive electrode with the electrically ignitable propellant. In another example, the electrodes are supplied an alternating current, which may initiate nearly simultaneously combustion of the electrically ignitable propellant at the contact locations of the electrodes with the electrically ignitable propellant. In some examples, one or more of the electrodes may include an insulator material insulating a portion of the electrode from the electrically ignitable propellant (which may burn away with combustion of the propellant).

In one configuration, a center insulated wire electrode is positioned along the axis of a cylindrical electrode in a coaxial configuration around the propellant (FIGS. 1a-1b). As combustion of the propellant is initiated, the insulation burns away and the propellant regresses along the axis. Testing has demonstrated that except for very small masses of propellant, the propellant ignites only at or near the center negative electrode (where the current density J is at a maximum) and burns down the electrode leaving a bulk of the propellant unconsumed. In another configuration, parallel plate electrodes are positioned to either side of the propellant (FIGS. 3a-3b). In the FIG. 3a embodiment, one of the parallel plate electrodes is insulated to produce combustion of the propellant to spread across the gain-end to the outer cathode. The combustion of the propellant propagates to the left along the axis of the structure, in a generally uniform manner as illustrated. Testing has again demonstrated that the propellant ignites only at or near the insulated negative plate electrode, e.g., burn back, leaving much of the propellant unconsumed. In contrast, in the FIG. 3b embodiment both of the plate electrodes are un-insulated. The propellant is broadly ignited along much of or the entire length of the positive electrode (i.e., the bulk of the propellant is ignited simultaneously).

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a gas generation system and method of ignition of electrically operated propellants for the controlled ignition of a single ignition surface to robustly and efficiently consume the propellant.

In an embodiment, an electrically operated propellant is positioned between a pair of electrodes. An ignition surface of the propellant contacts both electrodes at a minimum gap between the electrodes. In an ignition condition, an electrical input applied across the electrodes produces a maximum current density J at the minimum gap to ignite and burn at least a portion of the ignition surface without igniting the remaining bulk of the propellant to pressurize a combustion chamber. An actuator is configured to displace the electrically operated propellant or pair of electrodes to maintain positive contact between the electrically operated propellant and the pair of electrodes to continue burning at least a portion of the ignition surface with the continued application of the electrical input.

In an embodiment, the pair of electrodes is configured such that the current lines between the electrodes follow equipotential surfaces through the propellant. Absent non-uniformities in the propellant, an equipotential surface at the minimum gap corresponds to a surface of both uniform and maximum current density J. Notwithstanding such non-uniformities, the displacement of the propellant or pair of electrodes drives a contour of the ignition surface to substantially match the equipotential surface. As a result, substantially the entire ignition surface between the electrodes at the minimum gap ignites and burns, and continues burning as long as positive contact is maintained and the electrical input is applied. Absent such displacement the non-uniformities in the propellant may produce localized burning of the ignition surface, which is both less controllable and less efficient. The displacement that maintains positive contact allows the ignition surface to “find” the equipotential surface so that the entire ignition surface burns.

In an embodiment, the pair of electrodes is configured to be symmetric about a plane. The equipotential surface of uniform and maximum current density J terminates on either side of the minimum gap at the opposing electrodes. Consequently, the contour of the ignition surface is perpendicular to the plane of symmetry and approximately flat depending on the electrode structures. For example, a pair of flat plate electrodes has field lines that are ideally flat and even at the minimum gap. Alternately, a pair of angled plate electrodes has field lines that are curved and uneven. The amount of curvature is dictated by the angle of the plate electrodes and the conductivity of the propellant. The field lines are perpendicular to the plane of symmetry at the plane. The density of the field lines is a maximum at the minimum gap between the angled plate electrodes and falls off as the gap between the electrodes increases. A pair of rods (circular contact surface) would behave similarly to the angled plate electrodes. The rods may be configured to rotate and function as the actuator to pull the propellant to maintain the requisite positive contact. In different embodiments, multiple pairs of electrodes may be configured to ignite and burn a single piece of propellant or multiple pieces of propellants.

In an embodiment, the depth of the contact areas of the pair of electrodes is less than the initial depth of the propellant. In fact, the contact areas are preferably quite shallow. This reduces the power required to produce the electrical input to ignite the ignition surface, eliminates the possibility of igniting the remaining bulk of the propellant outside the electrodes and improves control over ignition of the single ignition surface. Furthermore, because the ignition surface remains at the minimum gap, the power requirements to ignite the propellant remain constant as the propellant is consumed.

In an embodiment, the propellant naturally tries to burn away from the electrodes in a generally linear direction (coincident with the plane of symmetry). Furthermore, the burning propellant creates gas that pressurizes the chamber, which tends to force the propellant away from the electrodes. The actuator is configured to produce a linear displacement of the propellant or pair of electrodes to maintain positive contact. The actuator may, for example, comprise various springs, linear actuators, screw drives, rotating rods, gas pressure or hydraulic pistons to produce the requisite linear force or displacement. In certain embodiments, the pressurized gas may be diverted behind the propellant to assist the actuator.

In different embodiments, the pair of electrodes is fixed and the actuator displaces the electrically operated propellant or the electrically operated propellant is fixed and the actuator displaces the electrodes. The later may be preferable when the mass of the propellant is substantially greater than the mass of the electrodes. In another embodiment, both the propellant and electrodes are displaced.

In an embodiment, the electrically operated propellant has a storage modulus of between 200 psi and 600 psi, suitably about 300 psi, that allows it to hold shape and be displaced by the actuator. The actuator may “extrude” the propellant to replace the material as it is consumed to maintain positive contact.

In an embodiment, the electrically operated propellant exhibits a self-sustaining threshold pressure at which the propellant once ignited cannot be extinguished and below which the propellant can be extinguished by interruption of the electrical input. This threshold may be as low as 150 psi and range up to 200, 500, 100, 1,500 and above 2,000 psi depending on the formulation of the propellant. Combustion of the propellant can be turned on and off via application and interruption of the electrical input as long as the chamber pressure does not exceed this threshold. In an embodiment, the electrically operated propellant includes an ionic oxidizer, a binder and a fuel. The ionic oxidizer, suitably a liquid when mixed, provides the free flowing ions necessary to create the local electrical signals in the propellant. For example, the oxidizer may be a liquid perchlorate based oxidizer.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1a-1d, as described above, illustrate an ignition sequence of electrically operated propellant using parallel wire electrodes;

FIGS. 2a-2d illustrate an embodiment of an ignition sequence of electrically operated propellant using flat plate electrodes and an actuator to maintain positive contact between the propellant and the electrodes;

FIGS. 3a-3d illustrate an embodiment of an ignition sequence of electrically operated propellant using angled plate electrodes and an actuator to maintain positive contact between the propellant and the electrodes;

FIG. 4 illustrates an embodiment of multiple angled plate electrodes alternating as anode and cathode to ignite a mass of electrically operated propellant;

FIGS. 5a-5b illustrate an embodiment of a rocket motor using springs to maintain positive contact between the electrically operated propellant and a pair of angled electrodes;

FIG. 6 illustrates an embodiment of a rocket motor using a linear actuator to maintain positive contact between the electrically operated propellant and a pair of angled electrodes;

FIG. 7 illustrates an embodiment of a gas generation system using coiled springs housed in the nozzle to maintain positive contact between the electrically operated propellant and a pair of angled electrodes;

FIG. 8 illustrates an embodiment of a pair of rotatable rods that provide both the electrode structure and the actuator to maintain positive contact with the electrically operable propellant.

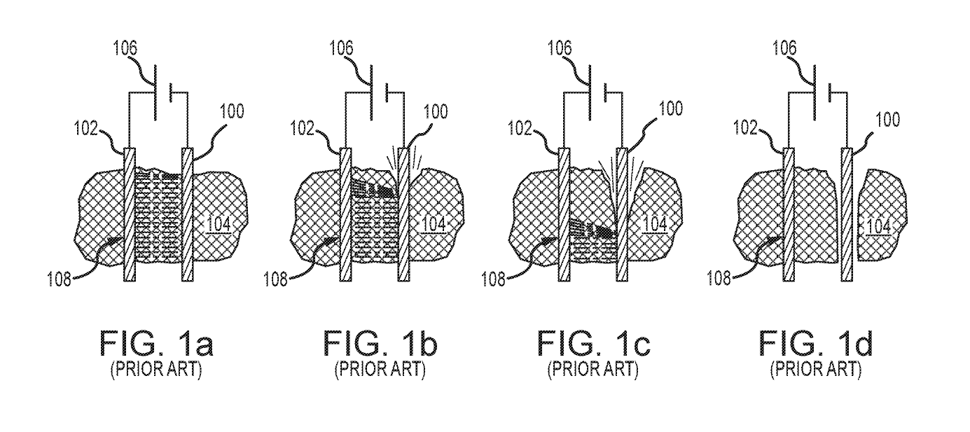

### DETAILED DESCRIPTION OF THE INVENTION

The present invention describes a gas generation system and method of igniting electrically controlled propellants to produce more reliable, robust, efficient and controlled ignition and burning of the propellant. More particularly, the system and method ignite and continue to burn an entire ignition surface and only that ignition surface of the propellant at a minimum gap between a pair of electrodes while avoiding burn back.

In its simplest configuration, an actuator is configured to displace the electrically operated propellant or a pair of electrodes to maintain positive contact between the electrodes and an ignition surface of the propellant at a minimum gap between the electrodes to sustain combustion of at least a part and preferably the entire ignition surface with continued application of an electrical input without igniting the remaining bulk of the propellant or suffering burn back. Such displacement overcomes any irregularities or imperfections or designed asymmetries in either the electrode configuration or the propellant itself to sustain ignition of the ignition surface.

In a more typical configuration, the electrodes are configured, preferably having contact areas symmetric about a plane, such that the current lines between the electrodes follow equipotential surfaces through the propellant. Absent non-uniformities in the propellant, an equipotential surface at the minimum gap corresponds to a surface of both uniform and maximum current density J.

Notwithstanding such non-uniformities, the displacement drives a contour of the ignition surface to substantially match the equipotential surface. As a result, substantially the entire ignition surface between the electrodes at the minimum gap, and only the ignition surface, ignites and burns, and continues burning as long as positive contact is maintained and the electrical input is applied. Absent such displacement the non-uniformities in the propellant may produce localized burning of the ignition surface, which is both less controllable and less efficient.

These configurations are useful for all varieties of electrical operated propellants. The configurations may be used with electrical operated propellants that exhibit no ability to be extinguished, propellants with a HAN-based oxidizer that exhibit a low self-sustaining threshold of about 150 psi, propellants with a perchlorate-based oxidizer that exhibit self-sustaining thresholds above 200, 500, 1,000, 1,500 or even 2,000 psi. U.S. Pat. No. 8,950,329 details the formulation of the perchlorate-based electrically operated propellant and is hereby incorporated by reference. The gas generation systems may be configured to simply burn the entire electrically operated propellant to extinction at a given burn rate, to control the burn rate and burn to extinction, to turn the combustion on and off, and back on again.

Without loss of generality, an embodiment of a gas generation system with an electrically operated propellant that can be throttled and turned on/off/on as long as the chamber pressure remains below the self-sustaining threshold pressure will be presented. An exemplary electrically operated propellant includes a metal-based fuel of approximate 5 to 30 percent of the mass of the propellant, a liquid perchlorate-based ionic oxidizer of approximately 50 to 90 percent of the mass and a binder of approximately 10 to 30 percent of the mass.

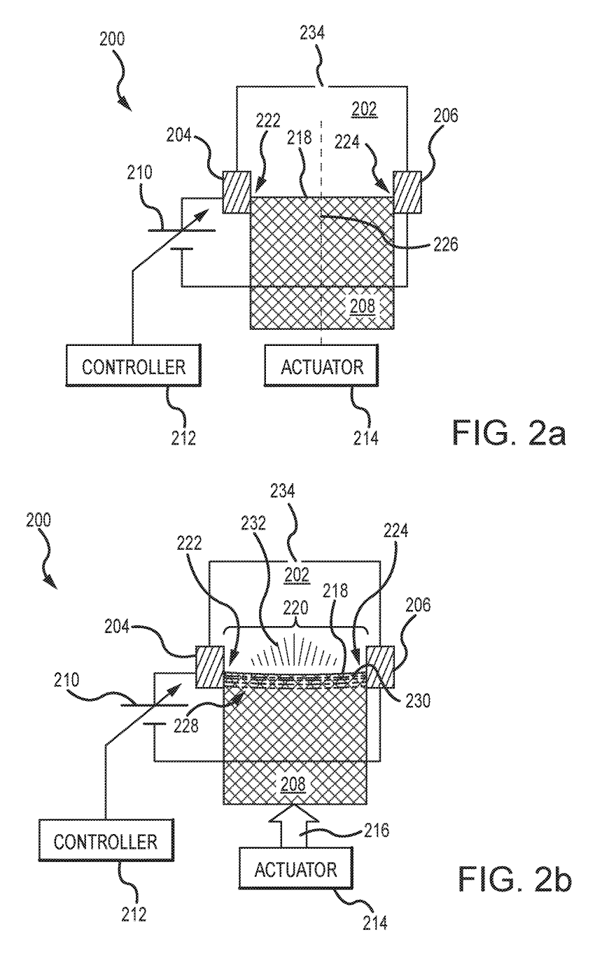

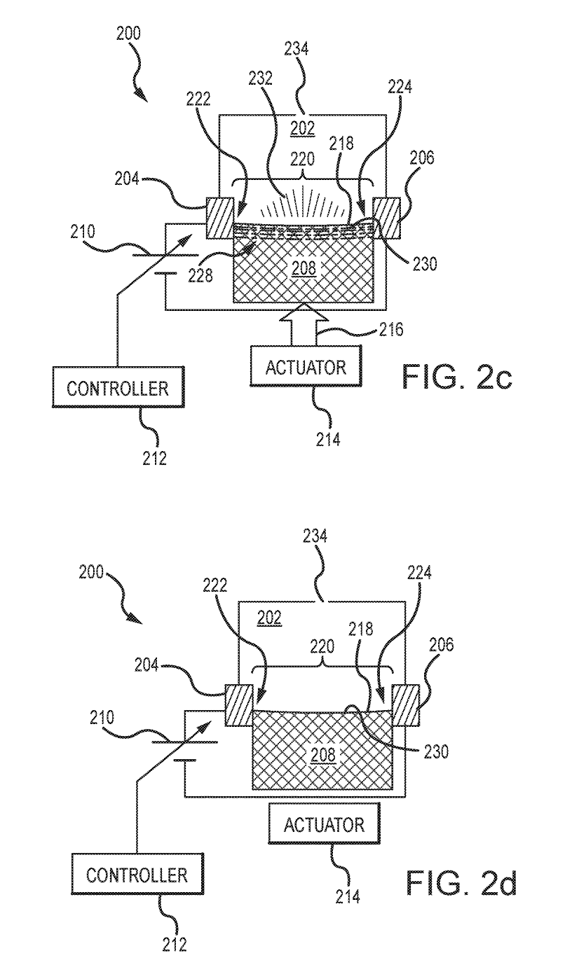

Referring now to FIGS. 2a-2d, an embodiment of a gas generation system 200 includes a combustion chamber 202, a pair of electrodes 204 and 206 and a mass of electrically operated propellant 208 positioned between the electrodes. The electrodes are coupled to an electrical power source 210 (e.g. a variable voltage source), which is controlled by a controller 212. An actuator 214 is positioned to apply a linear force 216 to a backside of the propellant to displace the propellant to maintain positive contact between the propellant and the electrodes. The actuator can be active (linear actuator) or passive (springs).

Electrodes 204 and 206 are flat plate electrodes that extend into propellant 208 orthogonal to linear force 216 and generally coplanar with an ignition surface 218 of the propellant at a minimum gap 220 between the electrodes. The contact surfaces 222 and 224 of the electrodes are symmetric about a plane 226 that extends into propellant 208.

The energized electrodes produce current (field) lines 228 that follow equipotential surfaces 230 that are ideally flat and even. Irregularities or imperfections due, for example, to non-homogeneous propellant may induce a small curvature to the field lines. One will note that the current (field) lines 228 are confined to the shallow volume where the electrodes are positioned and do not extend into the remaining bulk of the propellant 208. These equipotential surfaces 230 correspond to the ignition surface 218 of uniform and maximum current density J that exceeds an ignition threshold of the propellant.

In an ignition condition, an electrical input is applied across electrodes 204 and 206 to ignite and burn (at least 95%) the entire ignition surface 218 between electrodes to produce gases 232 that pressurize the combustion chamber. These gases may be released from the chamber through an opening 234 such as an orifice or nozzle. Actuator 214 applies linear force 216 to displace the mass of propellant 208 towards the electrodes to maintain positive contact between the propellant at the ignition surface 218 and the electrode contact surfaces 222 and 224. As the burning consumes the propellant at the ignition surface 218, the linear force displaces new propellant forward to replenish and maintain the ignition surface 218 between the electrodes to continue burning. The displacement tends to overcome any irregularities or imperfections caused, for example, by non-homogeneities in the propellant itself to drive the contour of the ignition surface 218 to the contour of the equipotential surface. This mechanism is what ensures that substantially the entire ignition surface ignites and combusts, as opposed to localized combustion on the surface or back burn. Combustion of the propellant produces gases that pressurize the combustion chamber.

In a throttling condition, controller 212 varies the electrical input to increase or decrease the rate of combustion to increase or decrease the pressure in the combustion chamber. In an extinguishment condition, provided the pressure in the chamber has not exceeded the propellant's self-sustaining threshold pressure, the controller interrupts the electrical input to extinguish combustion as shown in FIG. 2d. The propellant may be reignited by turning power back on to produce a maximum current density J at the ignition surface that exceeds the ignition threshold.

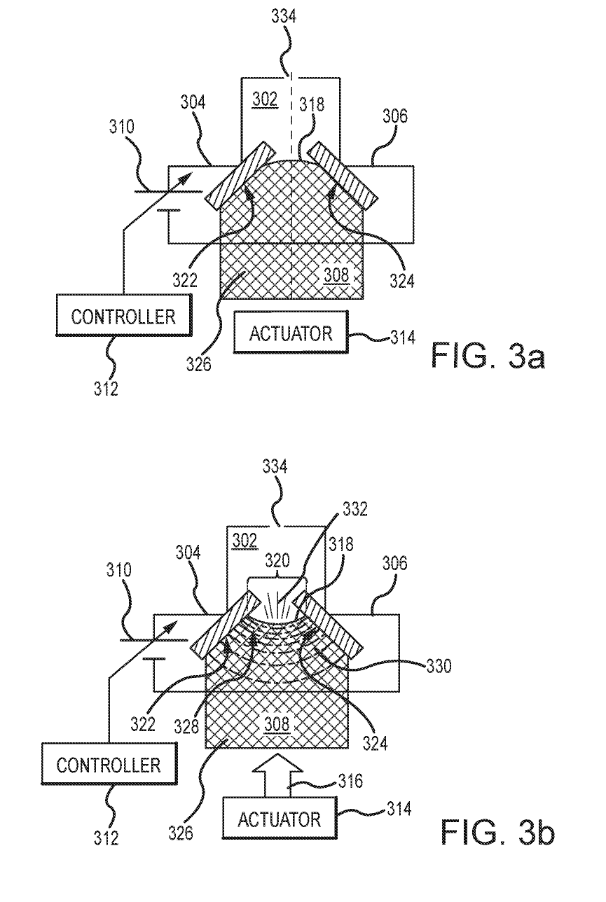

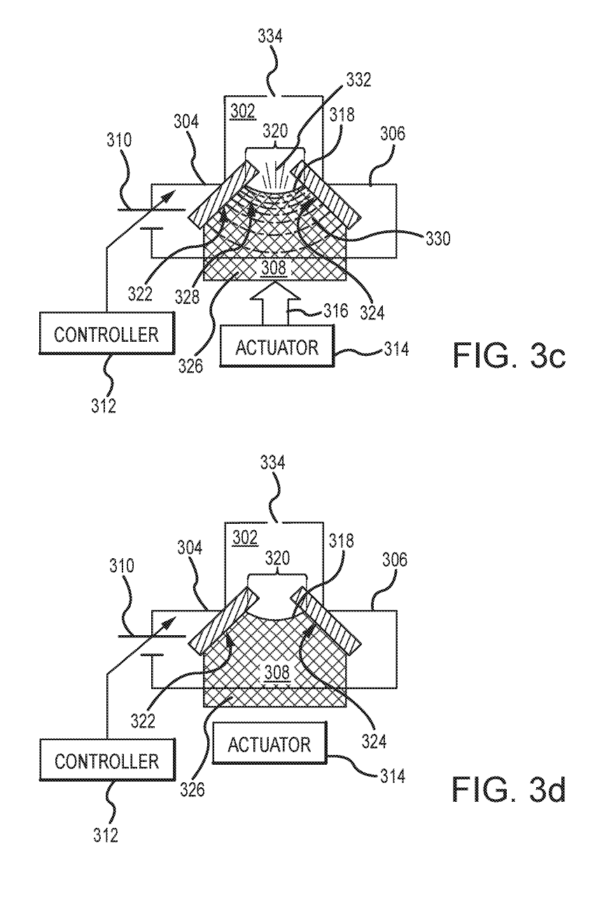

Referring now to FIGS. 3a-3d, an embodiment of a gas generation system 300 includes a combustion chamber 302, a pair of electrodes 304 and 306 and a mass of electrically operated propellant 308 positioned between the electrodes. The electrodes are coupled to an electrical power source 310 (e.g. a variable voltage source), which is controlled by a controller 312. An actuator 314 is positioned to apply a linear force 316 to the backside of the propellant to displace the propellant to maintain positive contact between the propellant and the electrodes.

Electrodes 304 and 306 are angled plate electrodes that extend into propellant 308 at an angle α roughly to an ignition surface 318 of the propellant at a minimum gap 320 between the electrodes. The minimum gap 320 is defined as the minimum gap between the electrodes that spans propellant. The angled contact surfaces 222 and 224 of the electrodes are symmetric about a plane 326 that extends into propellant 208.

The energized electrodes produce current (field) lines 328 that follow equipotential surfaces 330 that are ideally curved and unevenly spaced. The curvature is determined by the angle α and the conductivity of the propellant. Typical values of α are 10 to 80 degrees (where 0 degrees is the flat plate configuration shown in FIGS. 2a-2d). The spacing increases as the gap between the electrode increases and the concentration of field lines decreases. Irregularities or imperfections due, for example, to non-homogeneous propellant may induce small deviations in the curvature. One will note that the current (field) lines 328 are confined to the shallow volume where the electrodes are positioned and do not extend into the remaining bulk of the propellant 308. The equipotential surfaces 330 correspond to surfaces of uniform current density. The equipotential surface 330 at the minimum gap corresponds to the ignition surface 318 of uniform and maximum current density J that exceeds an ignition threshold of the propellant. The current density J decreases as the gap widens.

In an ignition condition, an electrical input is applied across electrodes 304 and 306 to ignite and burn substantially the entire ignition surface 318 between the electrodes at the minimum gap to produce gases 332 that pressurize the combustion chamber. These gases may be released from the chamber through an opening 334 such as an orifice or nozzle. Actuator 314 applies linear force 316 to displace the mass of propellant 308 towards the electrodes to maintain positive contact between the propellant at the ignition surface 318 and the electrode contact surfaces 322 and 324. As the burning consumes the propellant at the ignition surface, the linear force displaces new propellant forward to maintain the ignition surface 318 between the electrodes to continue burning. The displacement tends to overcome any irregularities or imperfections caused, for example, by non-homogeneities in the propellant itself to drive the contour of the ignition surface 318 to the curved contour of the equipotential surface at the minimum gap. This mechanism is what ensures that substantially the entire ignition surface ignites and combusts, as opposed to localized combustion on the surface or back burn. Combustion of the propellant produces gases that pressurize the combustion chamber.

In a throttling condition, controller 312 varies the electrical input to increase or decrease the rate of combustion to increase or decrease the pressure in the combustion chamber. In an extinguishment condition, provided the pressure in the chamber does not exceed the propellant's self-sustaining threshold pressure, the controller interrupts the electrical input to extinguish combustion. The propellant may be reignited by turning power back on to produce a maximum current density J that exceeds the ignition threshold.

The angled plate electrodes may be preferable to the flat plate electrodes because the shape of the field lines and current density is dominated by the geometry of the angle electrodes and the minimum gap. This effect dominates any undesired effects from non-uniformities in both the electrically operated propellant and the electrode surface by ensuring the current density macroscopically follows the perfect theoretical lines and microscopic non uniformities fall into the noise. Electrodes on the same order of the cross sectional area of the electrically operated propellant (e.g. if the propellant was 0.4 square inches, the electrode contact area was about 0.4 square inches too) further ensures that the field lines are dominated by geometric effects opposed to non uniformities and material properties. This provides more discrimination of the ignition surface, truly the top surface, not the entire depth of the flat plates etc.

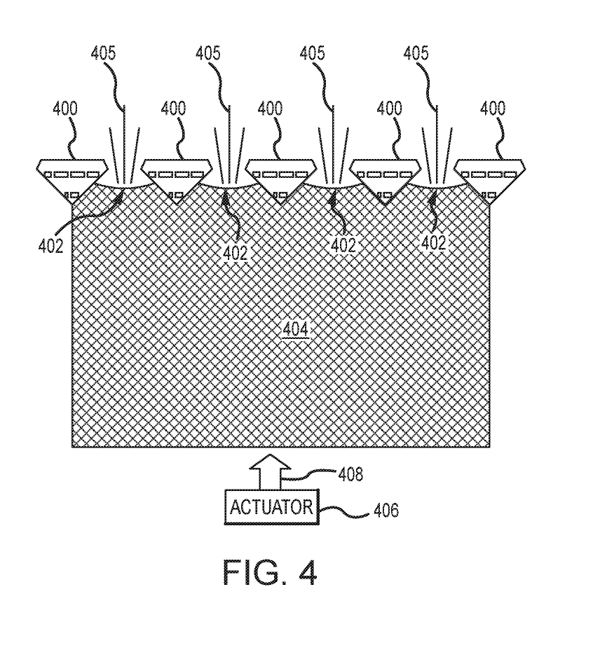

Referring now to FIG. 4, an embodiment of a gas generation system includes multiple electrodes 400, alternating as anode and cathode to form multiple pairs of electrodes. The electrodes are energized at the same time to burn the ignition surfaces 402 of the electrically operated propellant 404 at the same rate to produce gaseous products 405. An actuator 406 applies a linear force 408 to displace the propellant 404 to maintain positive contact with the electrodes 400. Alternately, each pair of electrodes may be provided with its own mass of electrically operated propellant. A common actuator or individual actuators may be configured to displace the different masses of propellant.

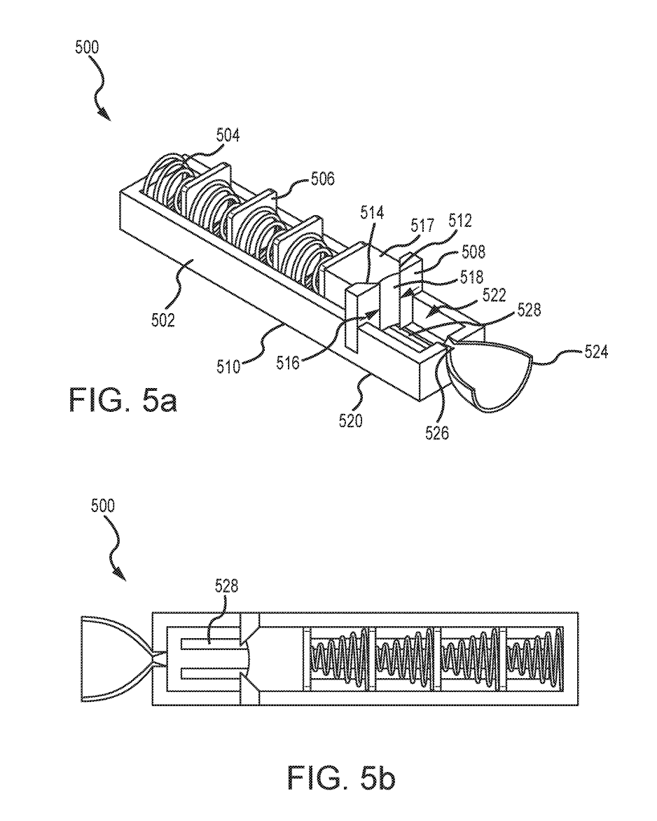

Referring now to FIGS. 5a-5b, an embodiment of a spring-actuated rocket motor 500 includes a body 502 in which is positioned a plurality of conical springs 504 separated by spring plates 506, one per spring. A pair of fixed electrodes 508 and 510 are positioned in body 502 forward of the last spring plate 506. The electrodes 508 and 510 have complementary angled contact areas 512 and 514, respectively, that define a minimum gap 516. A mass of electrically operated propellant 517 is positioned between the last spring plate 506 and the electrodes 508 and 510 with its forward most surface presenting an ignition surface 518 in the minimum gap 516. In this initial state, the conical springs 504 exert a linear force on the backside of propellant 517 that wants to displace the propellant forward into the electrodes and the minimum gap. The ignition surface 518 of the propellant, the forward surfaces of the electrodes 508 and 510 and a portion 520 of body 502 define a combustion chamber 522 forward of the minimum gap. A nozzle 524 is coupled to an opening 526 in the combustion chamber to expel high-pressure gas from the chamber to produce thrust for the rocket motor. The voltage source and controller are not depicted in this view. In certain embodiments, the rocket motor is provided with channels 528 to bleed a portion of the high-pressure gas from the chamber back behind the conical springs 504 to assist in pushing the electrically operated propellant to maintain positive contact and extrude the propellant.

In an ignition condition, an electrical input is applied across electrodes 508 and 510 to produce a maximum current density J across ignition surface 518 at minimum gap 516. This maximum current density J exceeds an ignition threshold required to ignite and burn the electrically operated propellant 517. As the propellant at the ignition surface is consumed, conical springs 504 exert the linear force to displace the propellant forward to replenish the ignition surface 518 in the minimum gap 516. The storage modulus of the propellant is such that the propellant may be “extruded” or “squeezed” to replenish the minimum gap. The ignition surface will find the contour of the current (field) lines between the electrodes. The ignition surface continues to burn as long as the electrical signal is applied or until the propellant is consumed.

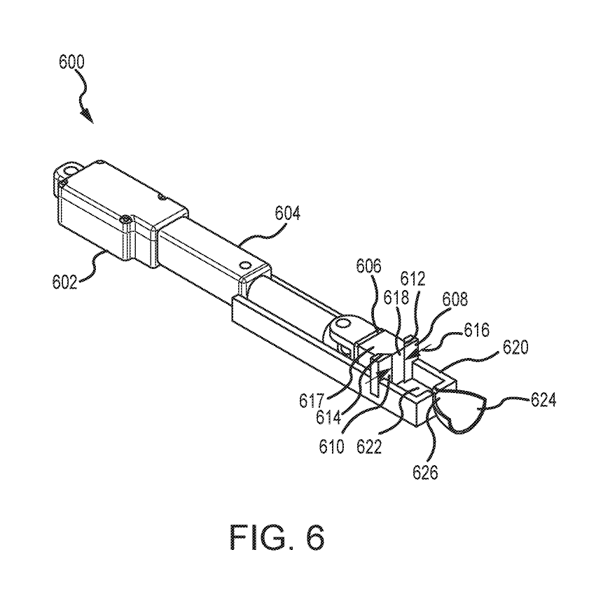

Referring now to FIG. 6, an embodiment of a linear actuator driven rocket motor 600 includes a body 602 in which is positioned a linear actuator 604 and a pushing plate 606. The pair of fixed electrodes 608 and 610 are positioned in body 602 forward of the pushing plate 606. The electrodes 608 and 610 have complementary angled contact areas 612 and 614, respectively, that define a minimum gap 616. A mass of electrically operated propellant 617 is positioned between the pushing plate 606 and the electrodes 608 and 610 with its forward most surface presenting an ignition surface 618 in the minimum gap 616.

In this initial state, the linear actuator 604 exerts either no force or a minimal a linear force on the backside of propellant 617 to hold the propellant against the electrodes. The ignition surface 618 of the propellant, the forward surfaces of the electrodes 608 and 610 and a portion 620 of body 602 define a combustion chamber 622 forward of the minimum gap. A nozzle 624 is coupled to an opening 626 in the combustion chamber to expel high-pressure gas from the chamber to produce thrust for the rocket motor. The voltage source and controller are not depicted in this view.

In an ignition condition, an electrical input is applied across electrodes 608 and 610 to produce a maximum current density J across ignition surface 618 at minimum gap 616. This maximum current density J exceeds an ignition threshold required to ignite and burn the electrically operated propellant 617. As the propellant at the ignition surface is consumed, linear actuator 604 exerts the linear force to displace the propellant forward to replenish the ignition surface 618 in the minimum gap 616. The actuator may be provided with feedback and a controller in order to maintain constant force. The storage modulus of the propellant is such that the propellant may be “extruded” or “squeezed” to replenish the minimum gap. The ignition surface will find the contour of the current (field) lines between the electrodes. The ignition surface continues to burn as long as the electrical signal is applied or until the propellant is consumed.

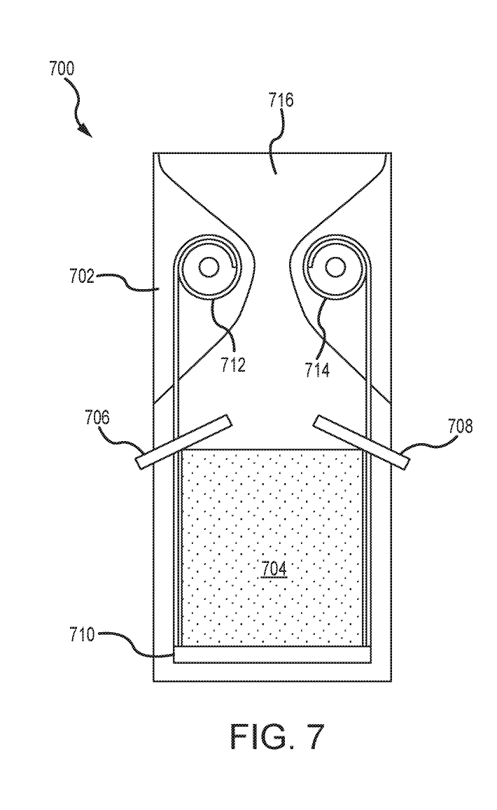

Referring now to FIG. 7, an embodiment of a spring-actuated rocket motor 700 includes a body 702 in which is positioned a mass of electrically operated propellant 704 between a fixed pair of angled plate electrodes 706 and 708 and a lift plate 710. A portion of body 702, the pair of electrodes and an ignition surface 712 of the propellant define a combustion chamber 714. The lift plate 710 is attached on opposite ends to constant force springs 712 and 714 housed in a nozzle 716 coupled to the combustion chamber. The springs exert a constant linear force upward on lift plate 710 to maintain positive contact between propellant 704 and the pair of electrodes. In an ignition condition, an electrical input is applied to the electrodes to ignite and burn ignition surface 712, which produces gaseous byproducts to pressurize the combustion chamber. The nozzle converts the high pressurized gas to high velocity gas to produce thrust for the rocket motor.

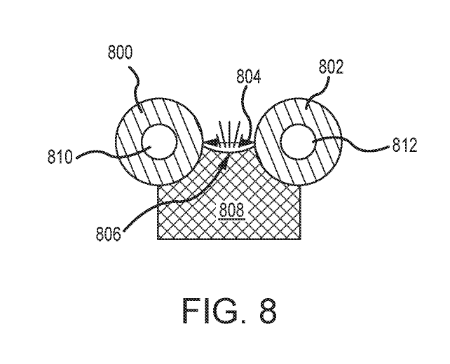

Referring now to FIG. 8, an embodiment combines the structure and function of the pair of electrodes and actuator in a pair of rotating rods 800 and 802. The cylindrical surfaces of the rods define a minimum gap 804 at which the current density J is a maximum. Similar to the angled plate electrodes, the cylindrical surfaces are angled along the curvature so that the gap widens and the current density J falls off, forcing ignition to be limited to an ignition surface 806 of an electrically operated propellant 808 at the minimum gap. The pair of rods also exhibit symmetry about a plane. As a result, the ignition surface 806 is driven to the contour of the current (field) lines.

To displace the propellant 808 the rods are driven to rotate in opposite directions (left rod 800 rotating in a counter clockwise direction and right rod 802 rotating in a clockwise direction) to produce a net linear force that pulls the propellant up into the minimum gap 804. Motors 810 and 812 can be configured to rotate rods 800 and 802 about their respective axes. The cylindrical surfaces of the rods may need to be treated or roughened in order to grip the propellant.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A gas generation system comprising:
a combustion chamber;
a pair of electrodes configured for coupling with an electrical power source;
an electrically operated propellant between the pair of electrodes, wherein in an ignition condition an electrical input is applied across the electrodes to ignite and burn at least a portion of an ignition surface of the propellant at a minimum gap and maximum current density J between the electrodes to produce pressurized gas in the combustion chamber; and
an actuator configured to displace the electrically operated propellant or the pair of electrodes to maintain positive contact between the electrically operated propellant and the pair of electrodes to continue burning at least a portion of the ignition surface.

2. The gas generation system of claim 1, wherein substantially the entire ignition surface ignites and continues to burn with the continued application of the electrical input.

3. The gas generation system of claim 2, wherein current lines between the electrodes follow equipotential surfaces through the propellant, wherein displacement of the propellant or pair of electrodes drives a contour of the ignition surface to substantially match the equipotential surface of maximum current density J.

4. The gas generation system of claim 3, wherein respective contact areas of the pair electrodes are symmetric about a plane, said equipotential surface of maximum current density terminating at the respective contact areas of the pair of electrodes at the minimum gap.

5. The gas generation system of claim 4, wherein the actuator is configured to displace the propellant or pair of electrodes substantially perpendicular to the ignition surface at the plane of symmetry.

6. The gas generation system of claim 4, wherein the pair of electrodes are flat plate electrodes spaced part by a constant gap equal to the minimum gap.

7. The gas generation system of claim 4, wherein the pair of electrodes are angled plate electrodes spaced apart by a non-uniform gap that opens to receive the propellant and tapers to the minimum gap at the ignition surface.

8. The gas generation system of claim 4, wherein the pair of electrodes are cylindrical rods spaced apart by the minimum gap, wherein said actuator comprises a pair of motors configured to counter rotate the cylindrical rods to pull the propellant to maintain positive contact between the cylindrical rods and the propellant.

9. The gas generation system of claim 1, further comprising multiple pairs of said electrodes.

10. The gas generation system of claim 1, wherein in an initial state prior to ignition said electrodes extending only a part of the way into the electrically operated propellant.

11. The gas generation system of claim 1, wherein the actuator comprises a linear actuator or one or more springs.

12. The gas generation system of claim 1, further comprising a nozzle coupled to the combustion chamber to exhaust high velocity gas to provide thrust, said actuator comprising a plurality of constant force springs built into the nozzle geometry and connected to a lift plate to displace the propellant to maintain positive contact.

13. The gas generation system of claim 1, wherein the electrically operated propellant has a storage modulus between 200 psi and 600 psi.

14. The gas generation system of claim 1, wherein the electrically operated propellant includes a perchlorate based oxidizer, said propellant having a self-sustaining threshold pressure of at least 500 psi at which the propellant once ignited cannot be extinguished and below which the propellant can be extinguished by interruption of an electrical input.

15. The gas generation system of claim 1, wherein the actuator comprises one or more springs, further comprising one or more channels coupled to the combustion chamber to bleed higher pressure gas from the chamber to the springs to assist in pushing the electrically operated propellant to maintain positive contact.

16. A gas generation system comprising:
a combustion chamber;
an electrically operated propellant a pair of electrodes configured for coupling with an electrical power source, said electrodes having angled contact areas that are symmetric about a plane whereby current lines follow equipotential surfaces through the propellant, one said equipotential surface corresponding to a surface of uniform and maximum current density at a minimum gap between the angled contact areas;
wherein in an ignition condition an electrical input is applied across the electrodes to ignite and burn an ignition surface of the propellant at the minimum gap; and
an actuator configured to displace the electrically operated propellant or the pair of electrodes to maintain positive contact between the electrically operated propellant and the pair of electrodes to drive a contour of the ignition surface to substantially match the equipotential surface at the minimum gap to continue burning substantially the entire ignition surface with the continued application of the electrical input.

17. A method of generating pressurized gas in a combustion chamber, comprising:
applying an electrical input across a pair of electrodes to ignite and burn at least a portion of an ignition surface of an electrically operated propellant positioned between the electrodes at a minimum gap between the electrodes; and
displacing the electrically operated propellant or the pair of electrodes to maintain positive contact between the electrically operated propellant and the pair of electrodes to continue burning at least a portion of the ignition surface.

18. The method of claim 17, further comprising configuring the pair of electrodes such that current lines between the electrodes follow equipotential surfaces through the propellant, wherein displacing the propellant or pair of electrodes drives a contour of the ignition surface to substantially match the equipotential surface of maximum current density J.

19. The method of claim 17, further comprising configuring the pair of electrodes such that respective contact areas are symmetric about a plane.

20. The method of claim 17, wherein displacing the electrically operated propellant comprises using one or more springs to produce a linear force on the propellant to maintain positive contact, further comprising bleeding high-pressure gas from the combustion chamber to the one or more springs to increase the linear force.
